(19) United States
(12) Patent Application Publication
(10) Pub. No.: US 2022/0413813 A1
(43) Pub. Date: Dec. 29, 2022

(54) METHOD AND SYSTEM FOR AUTOMATING DEVELOPMENT OF WHITE LABELED MEASUREMENT APPLICATION

(71) Applicant: MOZARK PTE. LTD., Singapore (SG)

(72) Inventors: Thierry MONCORGER, Marolles en Brie (FR); Wajdi Ben RABAH, Paris (FR)

(73) Assignee: MOZARK PTE. LTD., Singapore (SG)

(21) Appl. No.: 17/304,642

(22) Filed: Jun. 23, 2021

(51) Int. Cl. G06F 8/36; G06F 8/41

(52) U.S. Cl. CPC G06F 8/36; G06F 8/41

(57) ABSTRACT

The present disclosure provides a method and system for automating development of a white labeled measurement application using a white labeling automation system. The white labeling automation system receives a request from one or more clients for the development of the white labeled measurement application using an application development framework. In addition, the white labeling automation system obtains a set of client prerequisites from the one or more clients through one or more communication devices in real-time. Further, the white labeling automation system fetches a set of assets from the one or more clients to brand the white labeled measurement application according to a visual identity through a assets upload module. Furthermore, the white labeling automation system automates the development of the white labeled measurement application based on the request, the set of client prerequisites, and the set of assets using the application development framework.

### TECHNICAL FIELD

The present invention relates to the technical field of application development, and in particular, relates to a method and system for automating development of a white labeled measurement application.

### INTRODUCTION

Nowadays, developers use application development frameworks (ADFs) for implementing or developing desired applications. The ADFs provide a set of pre-defined code/data modules that may directly/indirectly used in the development of the desired applications. The ADFs may provide tools such as an IDE (integrated development environment), code generators, debuggers, etc. which facilitates the developers in coding or implementing desired logic of the desired applications. In general, application refers to a software program, which on execution performs specific desired tasks. In general, application development framework simplifies development of the desired applications by providing re-usable components and integrated development environments. This may be used by the application developers to define user interfaces and application logic by, for example, selecting components to perform desired tasks and defining the appearance, behavior, and interactions of the selected components. Additionally, white labeling of the desired applications while the development is recognized as important lever. Reselling a white-labeled application is a force multiplier in terms of revenue generation. However, present systems for developing the white-labeled application are inefficient, ineffective, labor-intensive, and therefore expensive.

### SUMMARY

In a first example, a computer-implemented method is provided. The computer-implemented method to automate development of a white labeled measurement application. The computer-implemented method includes a first step to receive a request from one or more clients for the development of the white labeled measurement application using an application development framework. In addition, the computer-implemented method includes a second step to obtain a set of client prerequisites from the one or more clients through one or more communication devices in real-time. Further, the computer-implemented method includes a third step to fetch a set of assets from the one or more clients to brand the white labeled measurement application according to a visual identity through a assets upload module. Furthermore, the computer-implemented method includes a fourth step to automate the development of the white labeled measurement application based on the request, the set of client prerequisites, and the set of assets using the application development framework.

In an embodiment of the present disclosure, the set of client prerequisites is associated with the visual identity and at least one measurement objective provided by the one or more clients.

In an embodiment of the present disclosure, the computer-implemented method manages license subscription for the one or more clients through a license subscription module in real-time.

In an embodiment of the present disclosure, the computer-implemented method configures a set of measurement protocol elements of the white labeled measurement application in real-time.

In an embodiment of the present disclosure, the set of assets includes an icon of the white labeled measurement application, a main logo, one or more color codes and texts in one or more languages. In addition, the set of assets includes an iconography override, one or more tutorial screens, one or more user terms and conditions and privacy.

In an embodiment of the present disclosure, the application development framework includes a library, a software development kit (SDK), at least one user interface, at least one backend and one or more hosts.

In an embodiment of the present disclosure, the computer-implemented method integrates the visual identity, the at least one measurement objective and the set of assets.

In an embodiment of the present disclosure, the computer-implemented method integrates a geographic information module with the white labeled measurement application in real-time.

In an embodiment of the present disclosure, the computer-implemented method publishes a plurality of key performance indicators in a form of at least one of a chart and a map.

In an embodiment of the present disclosure, the computer-implemented method compiles one or more binaries of the white labeled measurement application according to the application development framework.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method to automate the development of the white labeled measurement application. The method includes a first step to receive the request from the one or more clients for the development of the white labeled measurement application using the application development framework. In addition, the method includes a second step to obtain the set of client prerequisites from the one or more clients through the one or more communication devices in real-time. Further, the method includes a third step to fetch the set of assets from the one or more clients to brand the white labeled measurement application according to the visual identity through the assets upload module. Furthermore, the method includes a fourth step to automate the development of the white labeled measurement application based on the request, the set of client prerequisites, and the set of assets using the application development framework.

In an embodiment of the present disclosure, the set of client prerequisites is associated with the visual identity and the at least one measurement objective provided by the one or more clients.

In an embodiment of the present disclosure, the method further manages the license subscription for the one or more clients through the license subscription module in real-time.

In an embodiment of the present disclosure, the method further configures the set of measurement protocol elements of the white labeled measurement application in real-time.

In an embodiment of the present disclosure, the set of assets includes the icon of the white labeled measurement application, the main logo, the one or more color codes and the texts in the one or more languages. In addition, the set of assets includes the iconography override, the one or more tutorial screens, the one or more user terms and conditions and the privacy.

In an embodiment of the present disclosure, the application development framework includes the library, the software development kit (SDK), the at least one user interface, the at least one backend and the one or more hosts.

In an embodiment of the present disclosure, the method further integrates the visual identity, the at least one measurement objective and the set of assets.

In an embodiment of the present disclosure, the method further integrates the geographic information module with the white labeled measurement application in real-time.

In an embodiment of the present disclosure, the method publishes the plurality of key performance indicators in the form of the at least one of the chart and the map.

In an embodiment of the present disclosure, the method compiles the one or more binaries of the white labeled measurement application according to the application development framework.

In a third example, a non-transitory computer-readable storage medium is provided. The non-transitory computer-readable storage medium encodes computer executable instructions that, when executed by at least one processor, performs a method to automate the development of the white labeled measurement application. The method includes a first step to receive the request from the one or more clients for the development of the white labeled measurement application using the application development framework. In addition, the method includes a second step to obtain the set of client prerequisites from the one or more clients through the one or more communication devices in real-time. Further, the method includes a third step to fetch the set of assets from the one or more clients to brand the white labeled measurement application according to the visual identity through the assets upload module. Furthermore, the method includes a fourth step to automate the development of the white labeled measurement application based on the request, the set of client prerequisites, and the set of assets using the application development framework.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment to automate development of a white labeled measurement application, in accordance with various embodiments of the present disclosure;

FIG. 2 illustrates a block diagram of a white labeling automation system, in accordance with various embodiments of the present disclosure;

FIG. 3 illustrates a flowchart to automate the development of the white labeled measurement application, in accordance with various embodiments of the present disclosure; and

FIG. 4 illustrates a block diagram of a computing device, in accordance with various embodiments of the present disclosure.

There may be additional structures described in the description that are not depicted in the drawings, and the absence of such depictions should not be considered as an omission of such design from the specification.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

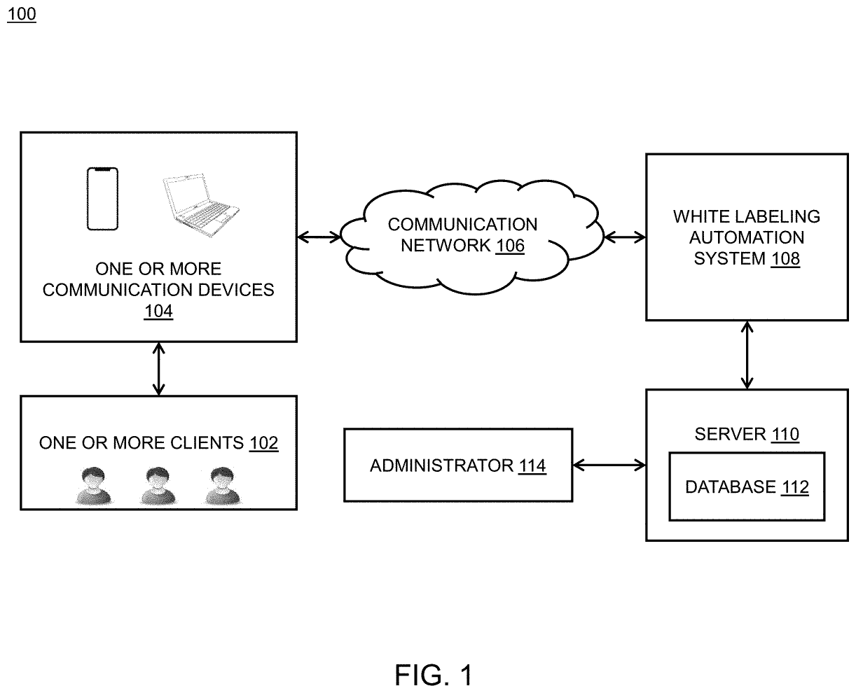

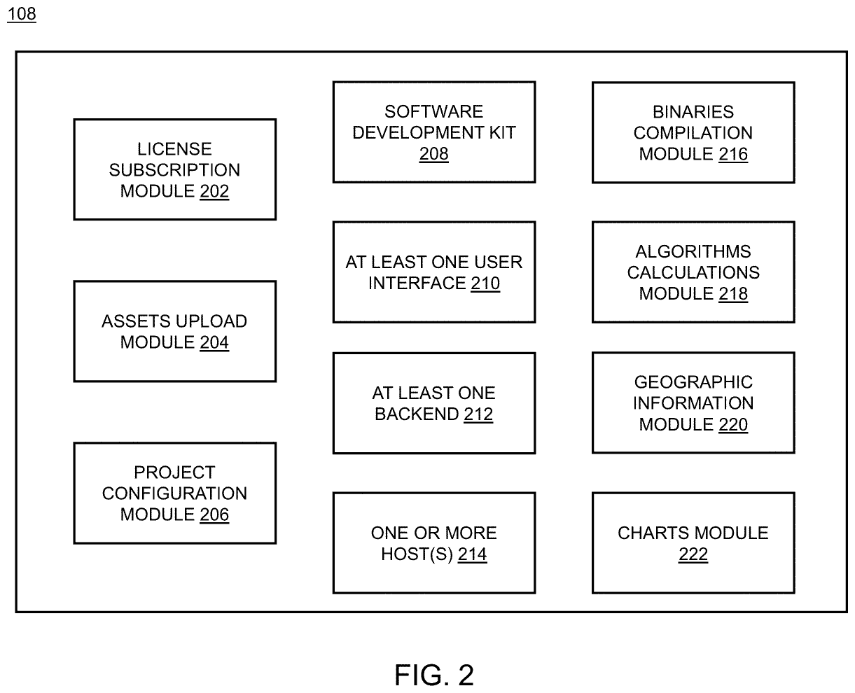

FIG. 1 illustrates an interactive computing environment 100 to automate development of a white labeled measurement application, in accordance with various embodiments of the present disclosure. FIG. 2 illustrates a block diagram of a white labeling automation system 108, in accordance with various embodiments of the present disclosure. The interactive computing environment 100 includes the one or more clients 102, one or more communication devices 104 and a communication network 106. In addition, the interactive computing environment 100 includes the white labeling automation system 108, a server 110, a database 112 and an administrator 114. The above stated elements of the interactive computing environment 100 operate coherently and synchronously to automate the development of the white labeled measurement application.

The interactive computing environment 100 includes the one or more clients 102. The one or more clients 102 may be any person or individual initiating the development of the white labeled measurement application using the white labeling automation system 108 on the one or more communication devices 104. In an embodiment of the present disclosure, each of the one or more clients 102 is an owner of the one or more communication devices 104. In another embodiment of the present disclosure, each of the one or more clients 102 is not the owner of the one or more communication devices 104. In an embodiment of the present disclosure, the one or more clients 102 access the one or more communication devices 104 at home. In another embodiment of the present disclosure, the one or more clients 102 access the one or more communication devices 104 at a cafe. In yet another embodiment of the present disclosure, the one or more clients 102 access the one or more communication devices 104 in an office.

The interactive computing environment 100 includes the one or more clients 102. The one or more clients 102 correspond to any number of person or individual associated with the white labeling automation system 108. The white labeling automation system 108 enables automated development of the white labeled measurement application for each of the one or more clients 102. In an example, the one or more clients 102 are owners of the white labeled measurement application. In another example, the one or more clients 102 are editors of the white labeled measurement application. In yet another example, the one or more clients 102 are any suitable entity.

The white labeled measurement application corresponds to a software program, that is white labeled and on execution performs measurement of an end user application experience and a comprehensive customer experience score associated with quality of the communication network 106. In addition, the white labeled measurement application is executed in a run-time environment containing one or more operating systems (“OSs”), virtual machines (e.g., supporting Java™ programming language), device drivers, and the like.

The end user application experience enables one or more developers or owners of one or more end user applications to initiate suitable actions to enhance the end user application experience. In addition, the end user application experience depends on a plurality of factors. Further, the plurality of factors includes signal strength, quality, transmission power, handover latency, Inter Radio Access Technologies, downlink throughput, uplink throughput, and latency. Furthermore, the plurality of factors include but may not be limited to packet loss, jitter, web latency of websites, and video latency from user end.

The white labeled measurement application recommends the suitable actions to the one or more developers or owners of the one or more end user applications to enhance the end user application experience. In addition, the white labeled measurement application predicts end user action based on the end user application experience to prevent loss of revenue.

In an embodiment of the present disclosure, the one or more end user applications include documentation applications, data management applications, financial applications, and entertainment applications. In another embodiment of the present disclosure, the one or more end user applications include educational applications, enterprise applications, simulation applications, media development applications, and the like. In addition, the one or more end user applications are developed by the one or more developers or owners. Further, the one or more developers or owners require to analyze the end user application experience.

The one or more clients 102 use an application development framework through the white labeling automation system 108 run on the one or more communication devices 104. In addition, the application development framework is used to implement or develop the white labeled measurement application. The application development framework of the white labeling automation system 108 provides a set of pre-defined modules (As Illustrated in FIG. 2) that may be directly/indirectly used in the development of the white labeled measurement application. Further, the application development framework provides development tools such as an integrated development environment (IDE), code generators, debuggers and the like. In general, application development framework simplifies application development by providing re-usable components that may be used by application developers or editors to define user interfaces and application logic.

The application development framework is launched when the one or more clients 102 start developing the white labeled measurement application. In addition, the one or more clients 102 are asked to give a set of client prerequisites at the application development framework through the one or more communication devices 104 in real-time. Further, the set of client prerequisites is associated with a visual identity and at least one measurement objective provided by the one or more clients 102 for the development of the white labeled measurement application. Furthermore, the one or more clients 102 are requested to provide a name and description for the white labeled measurement application.

The one or more clients 102 may select design for the white labeled measurement application from a set of pre-defined templates that may pre-seed end user interface. The end user interface is completed by specifying the name and description in the selected template, while a preview is automatically updated to show changes. In addition, the one or more clients 102 may use a palette to browse a catalog of available services and data sources that are available to the application development framework. Further, the one or more clients 102 see a list of attributes for each of the services and data sources, and using one or more gestures the one or more clients 102 may bind the list of attributes to the end user interface.

The one or more clients 102 may repeat process of feature definition and data-binding to create the white labeled measurement application. In addition, the one or more clients 102 may add other components such as maps, graphs, and the like to the end user interface. Further, the one or more clients 102 may publish the white labeled measurement application when the white labeled measurement application is ready for testing, so that one or more binaries are created (building native executables for iOS, Android, or any other mobile device OS), and a Quick Response (QR) code is subsequently generated and provided to the one or more clients 102. In an example, the one or more clients 102 scans the QR code by a mobile device, the white labeled measurement application is installed over the air onto the mobile device.

In an embodiment of the present disclosure, the set of pre-defined modules is used in the application development framework. The set of pre-defined modules offers data interaction, data visualization, and encapsulated browser side operations, and simplify rich client application development. In addition, the application development framework receives a request from the one or more clients 102 to build the white labeled measurement application. Further, the application development framework determines portions of one or more already developed applications that have been precompiled using a toolkit, and modifies declarative information associated with those existing applications.

The interactive computing environment 100 includes the one or more communication devices 104 that enable the one or more clients 102 to access the application development framework of the white labeling automating system 108. The one or more communication devices 104 are internet-enabled device to allow the one or more clients 102 to access the white labeling automating system 108.

In addition, the one or more communication devices 104 facilitate access to the white labeling automating system 108. In an embodiment of the present disclosure, each of the one or more communication devices 104 is a portable communication device. The portable communication device includes but may not be limited to a laptop, a smartphone, a tablet, and a smart watch. In an example, the smartphone may be an iOS-based smartphone, an android-based smartphone, a windows-based smartphone and the like. In another embodiment of the present disclosure, each of the one or more communication devices 104 is a fixed communication device. The fixed communication device includes but may not be limited to a desktop, a workstation, a smart TV and a mainframe computer. In an embodiment of the present disclosure, the one or more communication devices 104 are currently in the switched-on state. The one or more communication devices 104 are any type of devices having an active internet. In addition, each of the one or more clients 102 accesses corresponding communication device of the one or more communication devices 104 in real-time.

In an embodiment of the present disclosure, the one or more communication devices 104 perform computing operations based on a suitable operating system installed inside the one or more communication devices 104. In general, the operating system is system software that manages computer hardware and software resources and provides common services for computer programs. In addition, the operating system acts as an interface for software installed inside the one or more communication devices 104 to interact with hardware components of the one or more communication devices 104. In an embodiment of the present disclosure, each of the one or more communication devices 104 perform computing operations based on any suitable operating system designed for the portable communication device. In an example, the operating system installed inside the one or more communication devices 104 is a mobile operating system. Further, the mobile operating system includes but may not be limited to windows operating system, android operating system, iOS operating system, and Sailfish. However, the operating system is not limited to above mentioned operating systems. In an embodiment of the present disclosure, the one or more communication devices 104 operate on any version of particular operating system corresponding to above mentioned operating systems.

In another embodiment of the present disclosure, the one or more communication devices 104 perform computing operations based on any suitable operating system designed for fixed communication device. In an example, the operating system installed inside the one or more communication devices 104 is windows. In another example, the operating system installed inside the one or more communication devices 104 is Mac. In yet another example, the operating system installed inside the one or more communication devices 104 is Linux based operating system. In yet another example, the operating system installed inside the one or more communication devices 104 is Chrome OS. In yet another example, the operating system installed inside the one or more communication devices 104 may be one of UNIX, Kali Linux, and the like. However, the operating system is not limited to above mentioned operating systems.

In an embodiment of the present disclosure, the one or more communication devices 104 operate on any version of windows operating system. In another embodiment of the present disclosure, the one or more communication devices 104 operate on any version of Mac operating system. In yet another embodiment of the present disclosure, the one or more communication devices 104 operate on any version of Linux operating system. In yet another embodiment of the present disclosure, the one or more communication devices 104 operate on any version of Chrome OS. In yet another embodiment of the present disclosure, the one or more communication devices 104 operate on any version of particular operating system corresponding to above mentioned operating systems.

The one or more communication devices 104 enable the one or more clients 102 to access the application development framework of the white labeling automation system 108. The one or more communication devices 104 are internet-enabled devices that allow the one or more clients 102 to access the application development framework of the white labeling automation system 108 using the communication network 106. In an embodiment of the present disclosure, the white labeling automation system 108 is installed on the one or more communication devices 104. The white labeling automation system 108 allows the one or more clients 102 to automate the development of the white labeled measurement application. In another embodiment of the present disclosure, the white labeling automation system 108 runs on a plurality of web browsers installed on the one or more communication devices 104. In an example, the plurality of web browsers include but may not be limited to Opera, Mozilla Firefox, Google Chrome, Internet Explorer, Microsoft Edge, Safari and UC Browser. Further, the plurality of web browsers installed on the one or more communication devices 104 runs on any version of the respective web browser of the above mentioned web browsers. In an embodiment of the present disclosure, the one or more clients 102 installs the white labeling automation system 108 on the one or more communication devices 104. In another embodiment of the present disclosure, the one or more clients 102 access the white labeling automation system 108 on the plurality of web browsers installed on the one or more communication devices 104.

In an example, a user U1 connects with the interactive computing environment 100 through a communication device D1 (let's say a smartphone) to run the white labeling automation system 108. In another example, a user U2 connects with the interactive computing environment 100 through a communication device D2 (let's say a desktop computer) at home to access the white labeling automation system 108. In yet another example, the user U3 connects with the interactive computing environment 100 with a communication device D3 (let's say a tablet) while travelling to access the white labeling automation system 108.

Each of the one or more communication devices 104 comprises of a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processors read data from various entities such as memory or I/O components. The one or more processors execute the one or more instructions which are stored in the memory. The one or more processors provide execution method for one or more instructions provided by the white labeling automation system 108.

The interactive computing environment 100 includes the communication network 106. The one or more communication devices 104 are connected to the communication network 106. The communication network 106 provides a medium for the one or more clients 102 accessing the one or more communication devices 104 to connect with the white labeling automation system 108. In an embodiment of the present disclosure, the communication network 106 is an internet connection. In another embodiment of the present disclosure, the communication network 106 is a wireless mobile network. In yet another embodiment of the present disclosure, the communication network 106 is a wired network with a finite bandwidth. In yet another embodiment of the present disclosure, the communication network 106 is a combination of the wireless and the wired network for the optimum throughput of data transmission. In yet another embodiment of the present disclosure, the communication network 106 is an optical fiber high bandwidth network that enables a high data rate with negligible connection drops. The communication network 106 includes a set of channels. Each channel of the set of channels supports a finite bandwidth. Moreover, the finite bandwidth of each channel of the set of channels is based on capacity of the communication network 106. The communication network 106 connects the one or more communication devices 104 to the white labeling automation system 108 using a plurality of methods. The plurality of methods used to provide network connectivity to the one or more communication devices 104 includes 2G, 3G, 4G, 5G, Wifi and the like.

The interactive computing environment 100 includes the white labeling automation system 108. The white labeling automation system 108 automatizes the development of the white labeled measurement application published under the brand of the one or more clients 102. In addition, the white labeling automation system 108 receives the request from the one or more clients 102 for the development of the white labeled measurement application using the application development framework.

The white labeling automation system 108 obtains the set of client prerequisites from the one or more clients 102 through the one or more communication devices 104 in real-time. in addition, the set of client prerequisites is associated with the visual identity and the at least one measurement objective provided by the one or more clients 102 for the development of the white labeled measurement application.

The white labeling automation system 108 includes a license subscription module 202, an assets upload module 204, a project configuration module 206 and a software development kit 208. In addition, the white labeling automation system 108 includes at least one user interface 210, at least one backend 212, one or more hosts 214 and a binaries compilation module 216. Further, the white labeling automation system 108 includes an algorithms calculation module 218, a geographic information module 220 and a charts module 222. Furthermore, the software development kit 208, the at least one user interface 210, at least one backend 212 and one or more hosts 214 are components of the application development framework.

The white labeling automation system 108 manages license subscription for the one or more clients 102 through the license subscription module 202 in real-time. The license subscription module 202 enables the one or more clients 102 to subscribe and pay directly from a web portal for length or amount of expected end users. In addition, the license subscription module 202 enables the one or more clients 102 to select various rights such as application license, access to data, access to the one or more hosts 214, access to outputs and customization of scenarios. Furthermore, the license subscription module 202 enables the one or more clients 102 to disable at least one of a plurality of functionalities. The plurality of functionalities includes usage of the white labeled measurement application, access and export of a plurality of test results and availability of one or more outputs. In an example, the license subscription module 202 inactivates usage of the white labeled measurement application for the end users. In another example, the license subscription module 202 disables access to the plurality of test results. In yet another example, the license subscription module 202 disables availability of the one or more outputs such as at least one chart and at least one map.

The white labeling automation system 108 fetches a set of assets from the one or more clients 102 to brand the white labeled measurement application according to the visual identity through the assets upload module 204. The set of assets includes an icon of the white labeled measurement application, a main logo, one or more color codes and texts in the one or more languages. In addition, the set of assets includes an iconography override, one or more tutorial screens, one or more user terms and conditions and privacy.

The white labeling automation system 108 configures a set of measurement protocol elements of the white labeled measurement application in real-time using the project configuration module 206. The set of measurement protocol elements includes the set of assets, script edition, one or more result tabs, one or more countries or operators, one or more maps or barometer, and configuration of the one or more hosts 214. The script edition includes choice of proposal of a speed test, choice of the one or more host 216 for one or more throughput bitrate tests, choice of one or more tested web pages and choice of one or more tested videos. In an example, the project configuration module 206 enables the selection of at least one of the set of assets for the development of the white labeled measurement application. In another example, the project configuration module 206 enables selection of the one or more result tabs. In yet another example, the project configuration module 206 enables selection of the one or more countries or operators that has benchmark in barometer or map.

The white labeling automation system 108 provides the application development framework to automate the development of the white labeled measurement application in real-time. The application development framework includes a library, the software development kit 208 (SDK), the at least one user interface 210, the at least one backend 212 and the one or more hosts 214. The library available as the software development kit 208 is a test engine. In addition, the test engine performs a plurality of tests and measurements according to the customized scenario. The software development kit 208 works with the at least one user interface 210 and the at least one backend 212 that references the one or more hosts 214 and needed for bandwidth testing.

The at least one user interface 210 provided by the application development framework automates import of the set of assets uploaded by the one or more clients 102 over a source code project. In addition, the at least one backend 212 provided by the application development framework manages collected data of the plurality of test results as an input. Further, the at least one backend 212 provides one or more license rights and the one or more scenario parameters. Furthermore, the at least one backend 212 manages the one or more hosts 216 for the bandwidth testing and throughput testing. Moreover, the one or more hosts 216 correspond to a set of serves operating worldwide and available remotely.

The white labeling automation system 108 automates the development of the white labeled measurement application based on the request, the set of client prerequisites, and the set of assets using the application development framework. In addition, the white labeling automation system 108 integrates the visual identity, the at least one measurement objective and the set of assets for the development of the white labeled measurement application. Further, the white labeling automation system 108 integrates the geographic information module 220 with the white labeled measurement application in real-time. The white labeled measurement application may call for a single link that redirects to the geographic information module 220. Furthermore, the geographic information module 220 is queried based on the selection of the one or more countries or operators that has benchmark in the barometer or map. Moreover, the one or more clients may configure one or more filters proposed or selected.

The white labeling automation system 108 hosts and publishes a plurality of key performance indicators in a form of at least one of a chart and a map. In addition, the white labeling automation system 108 compiles the one or more binaries of the white labeled measurement application according to the application development framework using the binaries compilation module 216. The binaries compilation module 216 generates and delivers the one or more binaries of the white labeled measurement application after the automated uploading of the set of assets over the source code project. Further, the algorithms calculation module 218 creates the plurality of key performance indicators from one or more post processing test results for the one or more countries or operators using one or more analysis algorithms. The one or more analysis algorithms are run on the at least one backend 212. The white labeled measurement application may call for a single link that redirects to the charts module 222. Furthermore, the charts module 222 is queried based on the availability of the one or more outputs such as the at least one chart and the at least one map.

The interactive computing environment 100 includes the server 110 and the database 112. The white labeling automation system 108 is associated with the server 110. In general, server is a computer program or device that provides functionality for other programs or devices. The server 110 provides various functionalities, such as sharing data or resources among multiple clients, or performing computation for a client. However, those skilled in the art would appreciate that the white labeling automation system 108 is connected to more number of servers. Furthermore, it may be noted that the server 110 includes the database 112. However, those skilled in the art would appreciate that more number of the servers include more numbers of database.

In an embodiment of the present disclosure, the white labeling automation system 108 is located in the server 110. In another embodiment of the present disclosure, the white labeling automation system 108 is connected with the server 110. In yet another embodiment of the present disclosure, the white labeling automation system 108 is a part of the server 110. The server 110 handles each operation and task performed by the white labeling automation system 108. The server 110 stores one or more instructions for performing the various operations of the white labeling automation system 108. The server 110 is located remotely from the white labeling automation system 108. The server 110 is associated with the administrator 114. In general, administrator manages the different components in system. The administrator 114 coordinates the activities of the components involved in the white labeling automation system 108. The administrator 114 is any person or individual who monitors the working of the white labeling automation system 108 and the server 110 in real-time. The administrator 114 monitors the working of the white labeling automation system 108 and the server 110 through a communication device. The communication device includes the laptop, the desktop computer, the tablet, a personal digital assistant and the like.

The database 112 stores different sets of information associated with various components of the white labeling automation system 108. In general, database is used to hold general information and specialized data, such as the plurality of test results and the data of the comprehensive customer experience score, and the like. The database 112 stores the information of the library, the software development kit 208, the plurality of test results and the like. The database 112 organizes the data using model such as relational models or hierarchical models. Further, the database 112 stores data provided by the administrator 114.

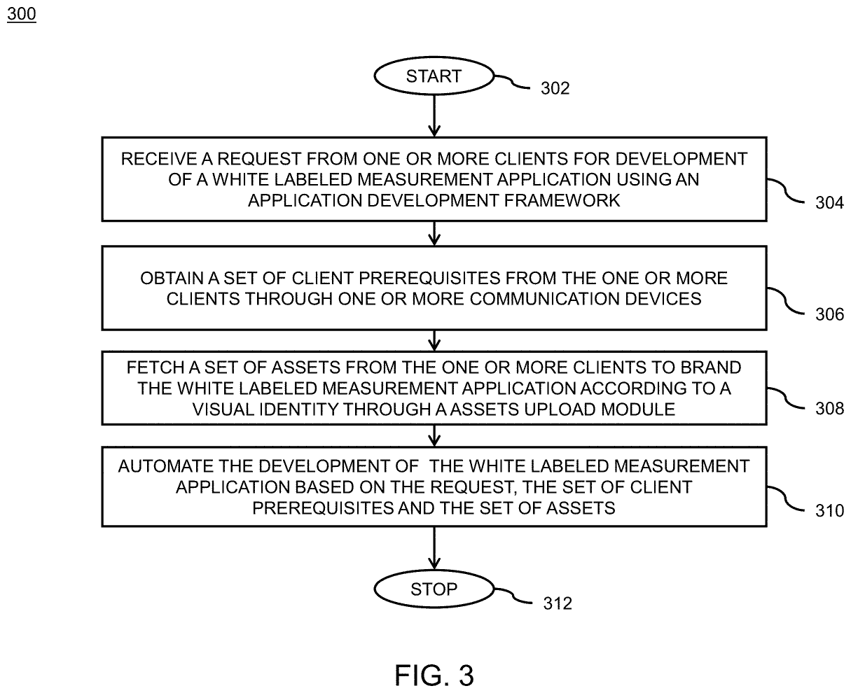

FIG. 3 illustrates a flowchart 300 to automate the development of the white labeled measurement application, in accordance with various embodiments of the present disclosure. It may be noted that in order to explain the method steps of the flowchart 300, references will be made to the elements explained in FIG. 1 & FIG. 2. The flowchart 300 starts at step 302. At step 304, the white labeling automation system 108 receives the request from the one or more clients 102 for the development of the white labeled measurement application using the application development framework. At step 306, the white labeling automation system 108 obtains the set of client prerequisites from the one or more clients 102 through the one or more communication devices 104 in real-time. At step 308, the white labeling automation system 108 fetches the set of assets from the one or more clients 102 to brand the white labeled measurement application according to the visual identity through the assets upload module 204. At step 310, the white labeling automation system 108 automates the development of the white labeled measurement application based on the request, the set of client prerequisites, and the set of assets using the application development framework.

The flowchart 300 terminates at step 312. It may be noted that the flowchart 300 is explained to have above stated process steps; however, those skilled in the art would appreciate that the flowchart 300 may have more/less number of process steps which may enable all the above stated embodiments of the present disclosure.

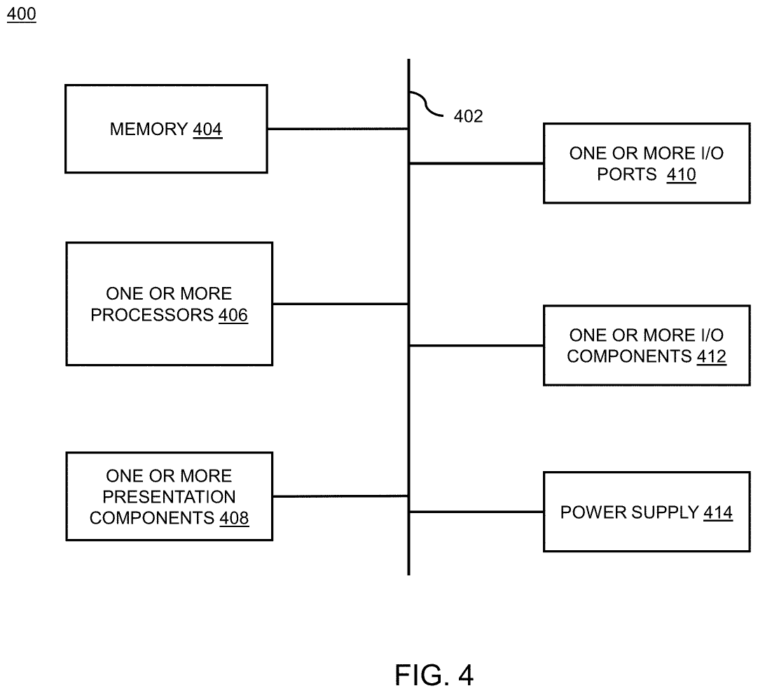

FIG. 4 illustrates the block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. The distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 404 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The computer-readable storage media associated with the memory 404 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The computing device 400 includes one or more processors that read data from various entities such as the memory 404 or I/O components 412. The one or more presentation components 308 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to explain the principles of the present technology best and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for automating development of a white labeled measurement application, the computer-implemented method comprising:
receiving, at a white labeling automation system with a processor, a request from one or more clients for the development of the white labeled measurement application using an application development framework;
obtaining, at the white labeling automation system with the processor, a set of client prerequisites from the one or more clients through one or more communication devices in real-time;
fetching, at the white labeling automation system with the processor, a set of assets from the one or more clients to brand the white labeled measurement application according to a visual identity through an assets upload module; and
automating, at the white labeling automation system with the processor, the development of the white labeled measurement application based on the request, the set of client prerequisites and the set of assets using the application development framework.

2. The computer-implemented method as recited in claim 1, wherein the set of client prerequisites is associated with the visual identity and at least one measurement objective provided by the one or more clients for the development of the white labeled measurement application.

3. The computer-implemented method as recited in claim 1, further comprising managing, at the white labeling automation system with the processor, license subscription for the one or more clients through a license subscription module, wherein the management of the license subscription is performed in real-time.

4. The computer-implemented method as recited in claim 1, further comprising configuring, at the white labeling automation system with the processor, a set of measurement protocol elements of the white labeled measurement application, wherein the set of measurement protocol elements of the white labeled measurement application is configured in real-time.

5. The computer-implemented method as recited in claim 1, wherein the set of assets comprises an icon of the white labeled measurement application, a main logo, one or more color codes, texts in one or more languages, an iconography override, one or more tutorial screens, one or more user terms and conditions and privacy.

6. The computer-implemented method as recited in claim 1, wherein the application development framework comprises a library, a software development kit (SDK), at least one user interface, at least one backend and one or more hosts.

7. The computer-implemented method as recited in claim 1, further comprising integrating, at the white labeling automation system with the processor, the visual identity, at least one measurement objective and the set of assets for the development of the white labeled measurement application.

8. The computer-implemented method as recited in claim 1, further comprising integrating, at the white labeling automation system with the processor, a geographic information module with the white labeled measurement application in real-time.

9. The computer-implemented method as recited in claim 1, further comprising hosting and publishing, at the white labeling automation system with the processor, a plurality of key performance indicators in a form of at least one of a chart and a map.

10. The computer-implemented method as recited in claim 1, further comprising compiling, at the white labeling automation system with the processor, one or more binaries of the white labeled measurement application according to the application development framework.

11. A computer system comprising:
one or more processors; and
a memory coupled to the one or more processors, the memory for storing instructions which, when executed by the one or more processors, cause the one or more processors to perform a method for automating development of a white labeled measurement application, the method comprising:
receiving, at a white labeling automation system, a request from one or more clients for the development of the white labeled measurement application using an application development framework;
obtaining, at the white labeling automation system, a set of client prerequisites from the one or more clients through one or more communication devices in real-time;
fetching, at the white labeling automation system, a set of assets from the one or more clients to brand the white labeled measurement application according to a visual identity through a assets upload module; and
automating, at the white labeling automation system, the development of the white labeled measurement application based on the request, the set of client prerequisites, and the set of assets using the application development framework.

12. The computer system as recited in claim 11, wherein the set of client prerequisites is associated with the visual identity and at least one measurement objective provided by the one or more clients for the development of the white labeled measurement application.

13. The computer system as recited in claim 11, further comprising managing, at the white labeling automation system, license subscription for the one or more clients through a license subscription module, wherein the management of the license subscription is performed in real-time.

14. The computer system as recited in claim 11, further comprising configuring, at the white labeling automation system, a set of measurement protocol elements of the white labeled measurement application, wherein the set of measurement protocol elements of the white labeled measurement application is configured in real-time.

15. The computer system as recited in claim 11, wherein the set of assets comprises an icon of the white labeled measurement application, a main logo, one or more color codes, texts in one or more languages, an iconography override, one or more tutorial screens, one or more user terms and conditions and privacy.

16. The computer system as recited in claim 11, wherein the application development framework comprises a library, a software development kit (SDK), at least one user interface, at least one backend and one or more hosts.

17. The computer system as recited in claim 11, further comprising integrating, at the white labeling automation system, the visual identity, at least one measurement objective and the set of assets for the development of the white labeled measurement application.

18. The computer system as recited in claim 11, further comprising hosting and publishing, at the white labeling automation system, a plurality of key performance indicators in a form of at least one of a chart and a map.

19. The computer system as recited in claim 11, further comprising compiling, at the white labeling automation system, one or more binaries of the white labeled measurement application according to the application development framework.

20. A non-transitory computer-readable storage medium encoding computer executable instructions that, when executed by at least one processor, performs a method for automating development of a white labeled measurement application, the method comprising:
receiving, at a computing device, a request from one or more clients for the development of the white labeled measurement application using an application development framework;
obtaining, at the computing device, a set of client prerequisites from the one or more clients through one or more communication devices in real-time;
fetching, at the computing device, a set of assets from the one or more clients to brand the white labeled measurement application according to a visual identity through a assets upload module; and
automating, at the computing device, the development of the white labeled measurement application based on the request, the set of client prerequisites, and the set of assets using the application development framework.
